(19) United States
(12) Patent Application Publication
(10) Pub. No.: US 2006/0195700 A1
(43) Pub. Date: Aug. 31, 2006

(54) Token signature

(75) Inventors: Akash A. Nankani, Redmond, WA (US); Arun K. Sacheti, Sammamish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/067,370

(22) Filed: Feb. 25, 2005

(51) Int. Cl. H04L 9/00

(52) U.S. Cl. 713/185

(57) ABSTRACT

Token signature techniques are described. In an implementation, a method includes obtaining a token that represents an offer and associating the token with a signature value which is calculated using the token. The signature value is configured for use in verifying that a user is in possession of the token.

### TECHNICAL FIELD

The present invention generally relates to tokens and more particularly relates to a token signature.

### BACKGROUND

A user has access to a variety of goods and services that are available via typical commerce (e.g., from a “bricks and mortar” store) as well as online commerce (e.g., e-commerce). For example, the user may interact with a wide variety of web sites over the Internet to purchase books, software, music, content subscriptions (e.g., streaming audio and video), and so forth. To increase traffic to sites (e.g., a web site, a physical store, and so on) which provide these goods and services, the sites may distribute offers for access to the goods and services, such as “10% off all purchases”, “free shipping”, and so on. In another instance, “special” offers may be provided to the user for continued loyalty, such as by providing a free gift after the purchase of a predetermined number of goods or services.

To protect these offers from attack and unauthorized distribution, tokens may be used to represent these offers. Thus, the tokens may be used to represent monetary values in commerce systems. Tokens may take a variety of forms, such as a string of characters that is provided by a user to represent the monetary value.

In some instances, however, a token may be rendered illegible and therefore unsuitable for use in representing the offer. For example, a user may be unable to read one or more characters which are included in the token. Consequently, the user is unable to provide the token for accessing the good or service, such as to enter each of the characters which form the token via a user interface provided by a web site. Additionally, a token verifier may be unable to even verify that the user is in possession of a valid token.

Therefore, there is a continuing need for verifying that the user is in possession of the token, even if one or more portions of the token are illegible to the user.

### SUMMARY

Token signature techniques are described. In an implementation, a method includes obtaining a token that represents an offer and associating the token with a signature value which is calculated using the token. The signature value is configured for use in verifying that a user is in possession of the token.

In another implementation, a method includes receiving a communication of a signature value and verifying that a token which corresponds to the signature value is possessed by an originator of the communication. The verifying includes comparing the signature value with another value, in which, the other value is computed at least in part from an intermediate value. The intermediate value is computed at least in part by processing the token using a one-way function.

In a further implementation, a method includes causing illegibility of at least a portion a token due to an attempt to expose the token on a medium and communicating a signature value included on the medium to verify possession of the medium. The signature value is calculated using the token.

### BRIEF DESCRIPTION OF THE DRAWINGS

FIG. 1 is an illustration of an environment in an exemplary implementation that is operable to employ signature techniques for tokens.

FIG. 2 is an illustration of a token system in an exemplary implementation showing a token source, a token distributor, and a token verifier of FIG. 1 in greater detail.

FIG. 3 is an illustration of an exemplary implementation showing a medium having a token, a signature value, and a sequence value.

FIG. 4 is a flow diagram depicting a procedure in an exemplary implementation in which a signature value is calculated from a token and utilized to verify whether a client has possession of a medium which includes the token and the signature value.

FIG. 5 is a flow diagram depicting a procedure in an exemplary implementation in which a one-way function that includes a secure hash algorithm is utilized to compute a signature value for inclusion on a medium for distribution.

FIG. 6 is a flow diagram depicting a procedure in an exemplary implementation in which a medium distributed via the procedure of FIG. 5 includes a signature value which is utilized to verify possession of the medium when the token is rendered illegible.

The same reference numbers are utilized in instances in the discussion to reference like structures and components.

### DETAILED DESCRIPTION

### Overview

Tokens are typically used in commerce systems to represent a monetary value of an offer, such as “10% off”, “buy one get one free”, and so on. For example, a user may purchase a card for 1,000 minutes of prepaid phone service. The card includes a token which is configured for entry by the user for accessing the prepaid phone service, and therefore corresponds to the offer (e.g., 1,000 minutes) for the service (e.g., phone service). In some instances, however, the token may be rendered illegible for use by the user, and consequently prevent the user from accessing the service.

The user, for instance, may purchase a prepaid phone card having a token which is hidden by a “scratch-off” material. Therefore, after the user has purchased the card, the scratch-off material may be removed so that the user can read the underlying token, and then provide the token for accessing the service. However, during the removal of the material, the user may render the underlying token illegible, such as by using an implement (e.g., a coin) to scratch the material off the prepaid card using an overly vigorous motion. Consequently, the user was not traditionally able to verify to a service provider that the user is actually in possession of the card, which may even require that the user send the actual card to the provider for verification.

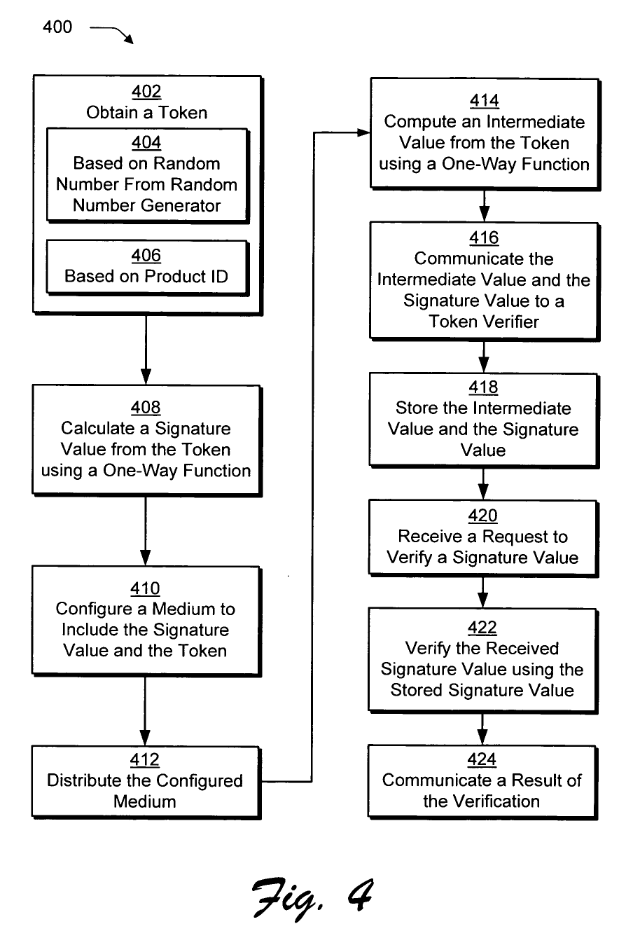

To verify that the user is in (or has had) possession of the card (and consequently the token), the card may include a signature value. For example, the signature value may be calculated from the token and included on the card. When the token is rendered illegible, the user may communicate the signature value and a sequence value of the card to the service provider. The service provider may then utilize the sequence value to locate a corresponding signature value, which is stored by the service provider, for verifying whether the received signature value is valid for that particular card. Thus, the service provider is able to verify that the user is in possession of the card. A variety of techniques may be employed which utilize a signature value, further discussion of which may be found beginning in relation to FIG. 4. In the following discussion, an exemplary environment is first described which is operable to employ the token signature techniques. Exemplary procedures are then described which may be performed in the exemplary environment, as well as in other environments.

### Exemplary Environment

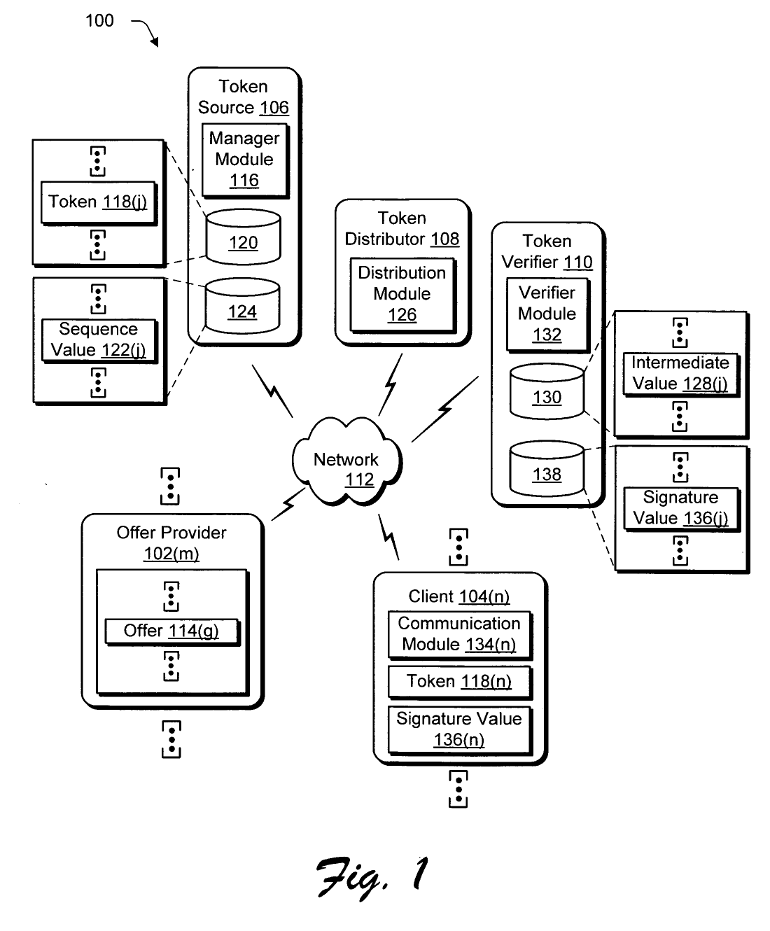

FIG. 1 is an illustration of an environment 100 in an exemplary implementation that is operable to employ the signature techniques for tokens. The illustrated environment 100 includes a plurality of offer providers 102(m) (where “m” can be any integer from one to “M”), a plurality of clients 104(n) (where “n” can be any integer from one to “N”), a token source 106, a token distributor 108, and a token verifier 110. Each of these entities is illustrated in the environment 100 of FIG. 1 as being communicatively coupled, one to another, over a network 112.

The clients 104(n) may be configured in a variety of ways. For example, the client 104(n) may be configured as a computing device that is capable of communicating over the network 112, such as a desktop computer, a mobile station, an entertainment appliance, a set-top box communicatively coupled to a display device, a wireless phone, a game console, and so forth. Thus, the clients 104(n) may range from full resource devices with substantial memory and processor resources (e.g., personal computers, game consoles) to a low-resource device with limited memory and/or processing resources (e.g., traditional set-top boxes, hand-held game consoles). The clients 104(n) may also relate to a person and/or entity that operate the clients. In other words, clients 104(n) may describe logical clients that include users, software and/or devices.

Although the network 112 is illustrated as the Internet, the network may assume a wide variety of configurations. For example, the network 112 may include a wide area network (WAN), a local area network (LAN), a wireless network, a public telephone network, an intranet, and so on. Further, although a single network 112 is shown, the network 112 may be configured to include multiple networks. For instance, the token source 106, token distributor 108 and token verifier 110 may be communicatively coupled via a corporate Intranet to communicate, one to another. Additionally, the token source 106, token distributor 108 and token verifier 110 may be communicatively coupled to the clients 104(n) over the Internet. A wide variety of other instances are also contemplated. Further, a variety of non-electronic networks may also be employed, such as through “in person” interaction between the clients 104(n) and a customer support person in contact with the token verifier 110.

The offer provider 102(m) is illustrated as including a plurality of offers 114(g), where “g” can be any integer from one to “G”. Each of the offers 114(g) corresponds to one or more of a plurality of goods and/or services. For example, the goods may include goods (e.g., such as books, digital video discs (DVDs), automobiles, and so forth) which are available for purchase (e.g., directly, via auction, and so on), rental, and so on by the plurality of clients 104(n). The services may represent services which are available for access by the clients 104(n). For example, the services may include services which are accessible to the client 104(n) over the network 112, such as to stream audio and/or video data, download programs, online games, and so on. The services may also include services which are available for purchase over the network 112, but which are then provided via other techniques, such as subscriptions to television programming, purchase of a wireless phone calling plan, and so on. The offer provider 102(m) may also provide the goods and/or services via a “bricks and mortar” store directly to the clients 104(n) without utilizing the network 112.

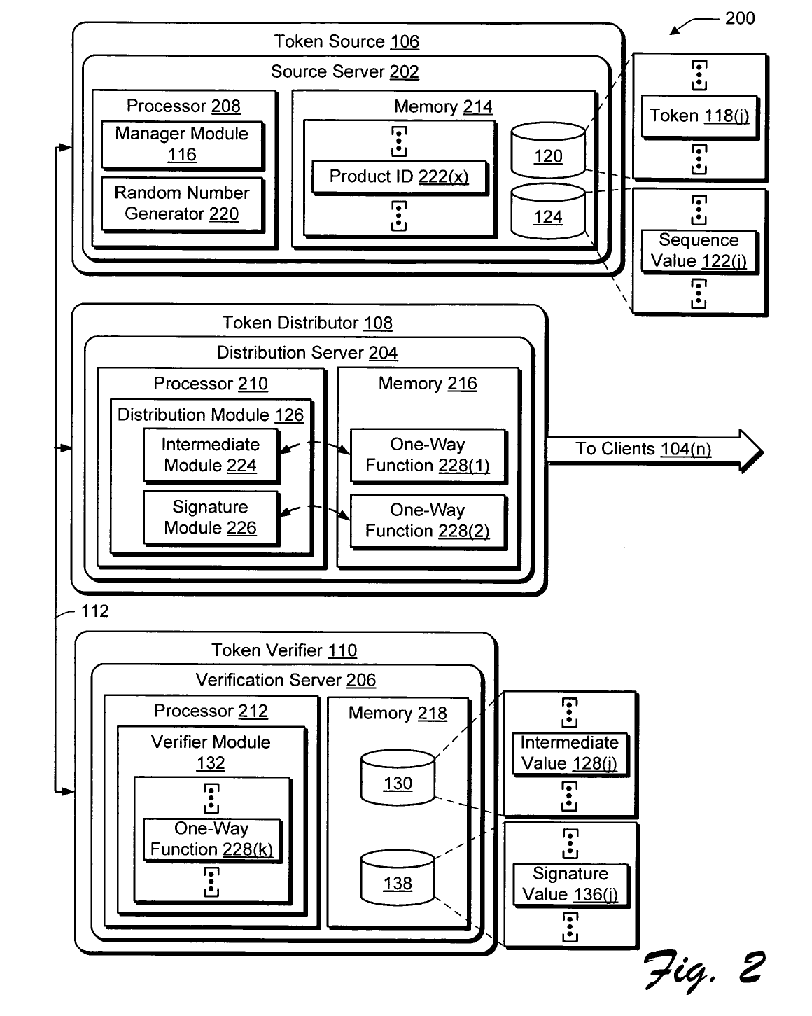

The token source 106 includes a manager module 116. The manager module 116 is executable to obtain tokens for distribution to the plurality of clients 104(n) to implement the offer 114(g), such as to purchase goods and services utilizing a reduction in price specified by the offer 114(g). For example, the manager module 116 may examine the offer 114(g) and obtain a corresponding token 118(j), where “j” can be any integer from one to “J”, for representing the offer 114(g). Although the plurality of tokens 118(j) are illustrated as included in storage 120, the tokens 118(j) may be obtained in a variety of ways, further discussion of which may be found in relation to FIG. 2.

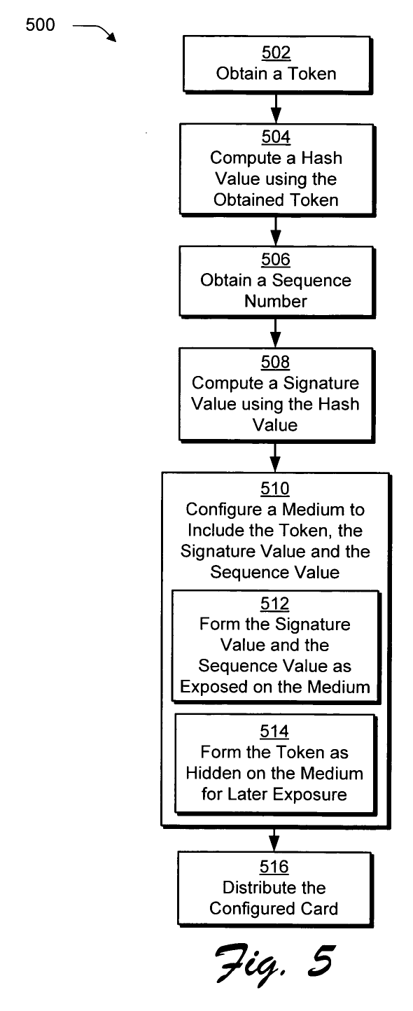

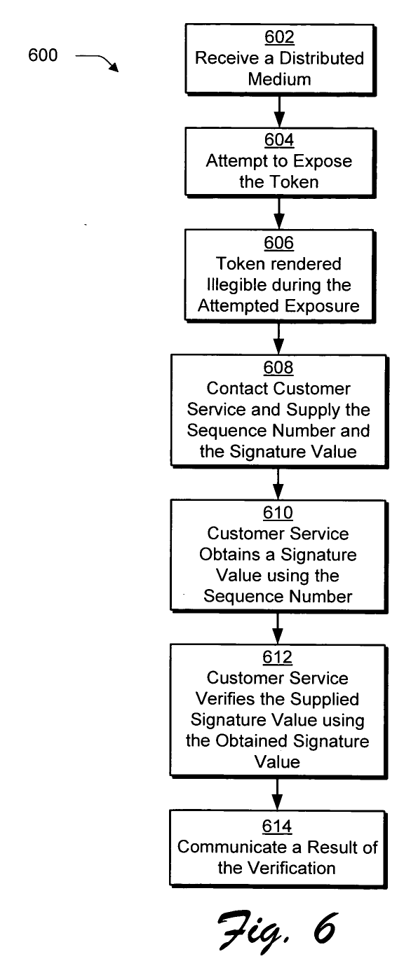

The token source 106 is also illustrated as including a plurality of sequence values 122(j) in storage 124. Each of the sequence values 122(j) in FIG. 1 corresponds to a respective one of the tokens 118(j). The sequence values 122(j) may be used to provide a variety of functionality, such as inventory control, billing, and so forth. For example, the sequence values 122(j) may be utilized to determine which of the plurality of tokens 118(j) are provided to the token distributor 108, which token is provided on a particular card, how many tokens are in circulation, and so forth. The sequence values 122(j) may also be utilized in the conjunction with the signature techniques, further discussion of which may be found in relation to FIGS. 5 and 6.

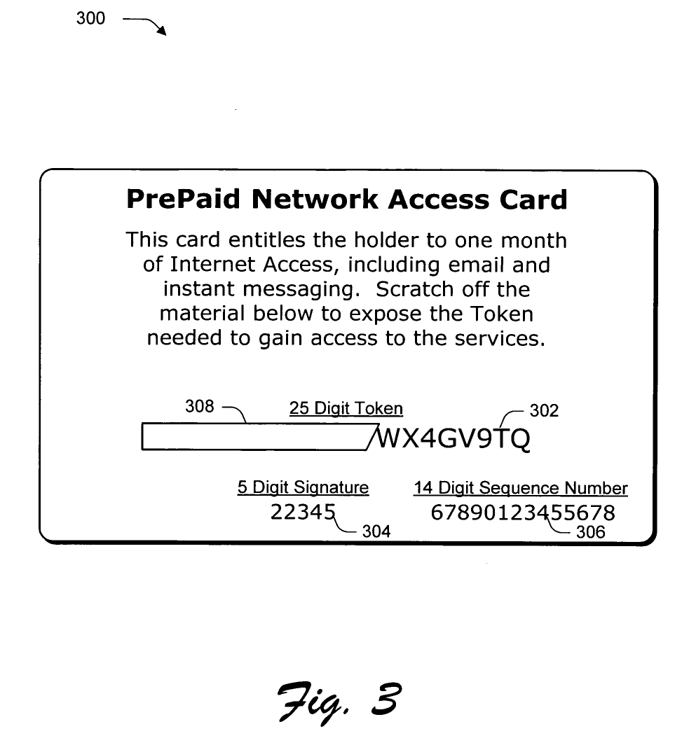

The token distributor 108 represents an entity for distributing tokens received from the token source 106. For example, the token distributor 108 may execute a distribution module 126 to distribute the tokens 118(j) received from the token source 106 over the network 112 to the plurality of clients 104(n). In another example, the distribution module 126 may be executed to form a medium having the token 118(j) for physical distribution to the client 104(n), further discussion of which may be found in relation to FIGS. 3-4.

The token distributor 108 may also execute the distribution module 126 to communicate a plurality of intermediate values 128(j) to the token verifier 110 for use in verifying whether the client 104(n) has obtained a valid token 118(j). For example, the distribution module 126, when executed, may employ a one-way function for computing an intermediate value 128(j) from a token 118(j) that is distributed by the token distributor 108. The intermediate value 128(j) may be communicated by the token distributor 108 over the network 112 to the token verifier 110 to store in storage 130. Thus, rather than store the token 118(j) itself in storage 130, and therefore expose the token 118(j) to possible attacks from malicious parties, the intermediate value 128(j) computed from the token 118(j) is stored in the storage 130.

The token verifier 110 may execute a verifier module 132 to determine whether a token 118(n) received from the client 104(n) is valid using the intermediate values 128(j). For instance, the client 104(n) may execute a communication module 134(n) to communicate token 118(n) over the network 112 to the token verifier 110. The verifier module 132 may compute an intermediate value from the token 118(n) using one or more one-way functions which were used to compute the intermediate values 128(j) in storage. In other words, the verifier module 132 may also be configured to utilize one or more one-way functions which were employed by the distribution module 126 to generate the intermediate values 128(j). If the intermediate value computed for the received token 118(n) matches one of the intermediate values 128(j) in storage 130, the verifier module 132 may determine that the token 118(n) is valid, and permit access to the offer 114(g). Thus, the verifier module 132 may determine validity without having access to the original token 118(j) provided by the token source 106.

A variety of one-way functions may be employed by the distribution module 126. For instance, a secure hash algorithm (e.g., U.S. Secure Hash Algorithm Version 1.0 (SHA-1)) may be utilized to compute the intermediate values 128(j) such that each of the intermediate values 128(j) is an irreversible value of the corresponding token 118(j). Thus, the intermediate values 128(j) cannot be utilized to “reverse” the intermediate value 128(j) to obtain the token 118(j) in its original form, which therefore protects the token 118(j) from malicious parties. For example, even if a malicious party obtains access to the storage 130, and consequently the intermediate values 128(j) in the storage 130, the token 118(j) cannot be computed from the intermediate value 128(j). Therefore, the malicious party does not obtain access to the token which is needed for verifying access to the offer 114(g). Further discussion of one-way functions may be found in relation to FIG. 2.

The token verifier 110 may also include a plurality of signature values 136(j) which are included in storage 138. The signature values 136(j) are configured to verify whether the client 104(n) has possession of the token 118(n). For example, the token 118(n) may have become illegible during distribution from the token distributor 108, during exposure of the token 118(n) by the client 104(n), and so on. Therefore, the client 104(n) may communicate the signature value 136(n) to the token verifier 110 when illegibility of the token 118(n) is encountered to verify that the client 104(n) is in possession of the token 118(n). The verifier module 132 may compare the signature value 136(n) received from the client 104(n) with the plurality of signature values 136(j) in storage 138 to determine whether the signature value 136(n) is valid. If so, the token verifier 110 may perform a variety of actions, such as to permit access to the offer 114(g), cause another one of the plurality of tokens 118(j) to be distributed to the client 104(n), and so on. Thus, the signature value 136(n) provides a technique for verifying token 118(n) possession without requiring physical transfer of a medium (e.g., a card) which includes the token 118(n) to the token verifier 110. Further discussion of the signature values 136(j) may be found in relation to FIG. 2.

Although the offer provider 102(m), client 104(n), token source 106, token distributor 108, and token verifier 110 are each illustrated separately in the environment 100 of FIG. 1, these entities may be combined and/or further separated in a variety of ways. For example, the offer provider 102(m) and the token source 106 may be provided by a single entity. In another example, the token source 106, token distributor 108, and token verifier 110 may be provided collectively by a token system.

Generally, any of the functions described herein can be implemented using software, firmware (e.g., fixed logic circuitry), manual processing, or a combination of these implementations. The terms “module” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the generation, distribution and verification techniques described below are platform-independent, meaning that the techniques may be implemented on a variety of commercial computing platforms having a variety of processors.

FIG. 2 is an illustration of a token system 200 in an exemplary implementation showing the token source 106, the token distributor 108, and the token verifier 110 of FIG. 1 in greater detail. The token source 106, the token distributor 108, and the token verifier 110 are illustrated as implemented in the token system 200 of FIG. 2, respectively, by a source server 202, a distribution server 204, and a verification server 206. Although a single server is shown for each of the token source 106, the token distributor 108, and the token verifier 110, the source server 202, the distribution server 204, and the verification server 206 may each be representative of one or more servers.

The source server 202, the distribution server 204, and the verification server 206 are each illustrated as including a respective processor 208, 210, 212 and respective memory 214, 216, 218. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 214-218 is shown, respectively, for the source server 202, the distribution server 204, and the verification server 206, the memory 214-218 is representative of a wide variety of types and combinations of memory that may be employed, such as random access memory (RAM), hard disk memory, removable medium memory, and so forth.

The source server 202 is illustrated as executing the manager module 116 on the processor 208, which is also storable in memory 214. As previously described, the manager module 116 is executable to obtain tokens 118(j), which may be performed in a variety of ways. For instance, the manager module 116 may obtain a random bit string through execution of a random number generator 220 and convert the random bit string to a number of alphanumeric characters. In another instance, the token is one of a plurality of product IDs 222(x), where “x” can be any integer from one to “X”. Product IDs may be implemented as unique serial number which are associated with a good or service. For example, product IDs may be utilized for verification that a particular good was purchased (i.e., not pirated) by a consumer, such as a product key for software, a personal computer, and so on. In such an example, the product ID itself may be utilized to leverage the existing distribution structure of the product and its product ID.

In a further instance, the token is obtained from a predefined token list that is obtained by the offer provider 102(m) of FIG. 1. For example, the offer provider 102(m) of FIG. 1 itself may also generate tokens for communication to and verification by the token system 200. In such an instance, the offer provider 102(m) may execute a module having functionality similar to that of the manager module 116.

The manager module 116 may also assign a sequence value 122(j) to each of the plurality of tokens 118(j). As previously described, the sequence values 122(j) may be utilized for a variety of purposes, such as inventory control, billing information, and so on. Additionally, the sequence value 122(j) may be utilized to retrieve the signature value 136(j), further discussion of which may be found in relation to FIG. 6.

The tokens 118(j) obtained by the token source 106 are distributed through use of the token distributor 108. The token distributor 108, for instance, may distribute the tokens 118(j) according to business rules specified by the corresponding offers 114(g) of FIG. 1. For example, the distribution server 206 may execute the distribution module 126 on the processor 210, which is also storable in memory 216, to form a communication having the token 118(j) for distribution across the network 112 to the client 104(n) of FIG. 1. In another example, the distribution module 126 is executable to incorporate the token 118(j) on a medium for distribution to the client 104(n) via other channels, such as through inclusion in an advertisement in a periodical (e.g., a flyer in a newspaper), and so on. Further discussion of token distribution may be found in relation to FIGS. 4-6.

The distribution module 126 is illustrated as including an intermediate module 224 and a signature module 226. The intermediate module 224 may be representative of functionality that is executable to generate the plurality of intermediate values 128(j) for use by the token verifier 110. For example, the intermediate module 224, when executed, may process the token 118(j) using a one-way function 228(a) to calculate the intermediate value 128(j). The distribution module 126 may then communicate the intermediate value 128(j) to the token verifier 110 for verifying the token 118(j). Thus, the token distributor 108 may distribute the intermediate value 128(j) to the token verifier 110 instead of the token 118(j), thereby further protecting the token 118(j) from malicious parties. Although a single one-way function 228(1) is illustrated as being utilized by the intermediate module 224, the one-way function 228(1) may be representative of multiple one-way functions. In addition, use of the one-way function 228(1) to generate the intermediate value 128(j) is not limited to a single use. For example, the intermediate module 224 may apply the one-way function 228(1) to the token 118(j) multiple times in order to generate the intermediate value 128(j).

The signature module 226 may be representative of functionality that is executable to generate the plurality of signature values 136(j) for use by the token verifier 110. The signature module 226, when executed, may process the token 118(j) using a one-way function 228(a) to calculate the signature value 136(j). The distribution module 126 may then communicate the signature value 136(j) to the token verifier 110 for verifying that a client 104(n) is in possession of the token 118(j), even if the token 118(j) is illegible. Again, this verification may be performed without the actual token 118(j), thereby protecting the token 118(j). Although a single one-way function 228(2) is illustrated as being utilized by the signature module 226, the one-way function 228(2) may be representative of multiple one-way functions. In addition, use of the one-way function 228(2) to generate the signature value 136(j) is not limited to a single use. For example, the signature module 226 may apply the one-way function 228(2) to the token 118(j) multiple times in order to generate the signature value 136(j).

Further, although the one-way function 228(1) utilized by the intermediate module 224 is illustrated as separate from the one-way function 228(2) utilized by the signature module 226, the intermediate module 224 and the signature module 226 may share the same one way function. For example, the intermediate module 224 may utilize a secure hash algorithm to calculate a 20-character intermediate value 128(j). The signature module 226 may also utilize the same secure hash algorithm to calculate a 5 character signature. A variety of other examples are also contemplated. For instance, the signature value 136(j) may be configured as the first 5 characters of the intermediate value 128(j). Thus, in such an instance, the token distributor 108 may communicate the intermediate values 128(j) to the token verifier 110, which may then derive the signature values 136(j) itself from the intermediate values 128(j). Further discussion of signature value 136(j) calculation may be found in relation to FIGS. 4-5.

The token verifier 110 is illustrated as executing a verifier module 132 on the processor 212 of the verification server 206, which is also storable in memory 218. The verifier module 132, when executed, verifies when a token communicated from one of the plurality of clients 104(n) is valid. For example, the verifier module 132 may utilize one or more of a plurality of one-way functions 228(k), where “k” can be any integer from one to “K”. One or more of the plurality of one-way functions 228(k) correspond to the one-way functions 228(1) utilized by the intermediate module 224 to compute the intermediate value 128(j). Therefore, when the verifier module 132 receives a token from one of the clients 104(n), the received token is processed to generate an intermediate value. The generated intermediate value may then be compared through execution of the verifier module 132 with the plurality of intermediate values 128(j) to find a match. In an implementation, the plurality of intermediate values 128(j) was previously generated from tokens 118(j) distributed by the token distributor 108. Thus, if the generated intermediate value matches an intermediate value in storage 130, the token received from the client 104(n) was distributed by the token distributor 108. This match may then be utilized to permit use of the offer corresponding to the token to the client 104(n), such as a discount for a referenced good or service.

The verifier module 132 may also be executable to verify whether a signature value received from one of the clients 104(n) is valid. For example, the verifier module 132 may compare a received signature value with the stored signature values 136(j) to find a match. In another example in which the signature values 136(j) are portions of the intermediate values 128(j), the verifier module 132 may receive a signature value and a sequence value from a client. The verifier module 132 may then utilize the sequence value as an index to locate a corresponding intermediate value 128(j). If the received signature value matches a portion of the intermediate value 128(j) (e.g., the first five characters), the received signature value is valid. A variety of other techniques may be utilized to form and verify signature values, further discussion of which may be found in relation to FIGS. 4-6.

Although the token system 200 of FIG. 2 is illustrated as implemented by a source server 202, distribution server 204, and verification server 206, the corresponding functionality may be provided collectively by a single system, combined across various other systems, and so on. Thus, the token system 200 of FIG. 2 is an example of one of a variety of systems which are operable to employ the signature techniques described herein.

FIG. 3 is an illustration of an exemplary implementation showing a medium 300 having a token 302, a signature value 304, and a sequence value 306. The token 302 is illustrated as being partially obscured by a scratch-off material 308 that is placed over the token 302. For example, the distribution module 126 of FIG. 2 may be executed to control one or more machines which form the token, the signature value 304, and the sequence value 306 on the medium, such as by printing and so forth. The distribution module 126 may then cause the scratch-off material 308 to be formed over the token 302 to obscure the token 302 from view. Therefore, a user is not typically able to view the token 302 until after the card has been purchased.

Although a medium 300 configured as a prepaid network access card is shown for purchasing a conditional right to gain network access, the medium 300 may be configured in a variety of ways to represent a variety of goods or services. For example, the medium 300 may be configured as a scratch-off lottery ticket, a prepaid phone card, an advertisement which includes an offer for a good or service, and so on.

### Exemplary Procedures

The following discussion describes generation, distribution and verification techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the token system 200 of FIG. 2.

FIG. 4 is a flow diagram depicting a procedure 400 in an exemplary implementation in which a signature value is calculated from a token and utilized to verify whether a client has possession of a medium which includes the token and the signature value. A token is first obtained (block 402), which may be performed in a variety of ways. For example, the token may be based on a random number from a random number generator (block 404). In another example, the token may be based on a product ID (block 406).

A signature value is calculated from the token using a one-way function (block 408). For example, the signature value may be an irreversible value of a corresponding token. Thus, the signature value cannot be utilized to “reverse” the signature value to obtain the token in its original form, which therefore protects the token from malicious parties. For example, even if a malicious party obtains access to the storage 138, and consequently the signature values 136(j) in the storage 138, the token 118(j) cannot be computed from the signature values 136(j). Therefore, the malicious party does not obtain access to the token which are needed for verifying access to the offers 114(g).

A medium is then configured to include the signature value and the token (block 410). The medium, for instance, may be configured from a variety of physical materials, such as cardboard, plastic, paper, metal, and so forth, on which the signature value and the token are formed. The medium may also be configured as a medium for containing computer-readable data, and therefore may include a CD-ROM, a medium for transporting computer-executable instructions over a network (e.g., a phone line, a network cable), and so on.

The configured medium is then distributed (block 412). For example, the physical medium of the previous instance may be distributed in a variety of ways, such as a leaflet in a newspaper or other periodical, a lottery ticket provided for purchase, a prepaid card available from a vending machine, and so on. In another example in which the medium is configured to store computer-readable data, the medium may be emailed, text messaged, provided via a web site, and so on.

An intermediate value is computed from the token using a one-way function (block 414). For example, the intermediate value may be computed using the same one-way function used to calculated the signature value (block 408). In another example, the intermediate value may be computed using a different one-way function. Further, the one-way function may be part of additional processing that is performed to arrive at the intermediate value. In other words, the computation of the intermediate value using the one-way function is not limited to the use of the one-way function, but may also involve other functions and processing.

The intermediate value and the signature value are communicated to a token verifier (block 416), which are then stored for later retrieval (block 418). For example, the intermediate value 128(j) and the signature value 136(j) may be communicated over the network 112 and stored in storage 130. In another example, the intermediate value 128(j) and the signature value 136(j) are written to a computer-readable medium (e.g., a CD-ROM) which is then physically delivered to the token verifier 110. A variety of other examples are also contemplated.

The token verifier may then receive a request to verify a signature value (block 420). For example, the configured medium which was distributed (block 412) to the client may have become damaged such that the token is no longer legible. Therefore, the client 104(n) may send a communication over the network 112 to the token verifier 110 which includes the signature value 136(n). The token verifier 110 may then verify the received signature value using the stored signature value (block 422). For instance, the token verifier may determine whether the signature value 136(j) stored in storage 138 (block 418) matches the signature value 136(n) received from the client 104(n) over the network 112.

A result of the verification is communicated (block 424). For example, the token verifier 110 may communicate the result to a customer service representative that the signature value is valid, and therefore the client should receive a new token. In another example, the token verifier 110 may permit access to the offer 114(g) represented by the token. A variety of other actions may also be performed without departing from the spirit and scope thereof.

In this exemplary implementation, separate signature values and intermediate values were communicated to the token verifier 110. In another implementation, the signature value corresponds to a portion of the intermediate value, and therefore may be communicated as a single unit, further discussion of which may be found in relation to the following figures.

FIG. 5 is a flow diagram depicting a procedure 500 in an exemplary implementation in which a one-way function which includes a secure hash algorithm is utilized to compute a signature value for inclusion on a medium for distribution. A token is obtained (block 502), which may be performed in a variety of ways, such as by generating the token using a random number generator, assigning a product ID, and so forth.

A hash value is then computed using the obtained token (block 504). For example, U.S. Secure Hash Algorithm Version 1.0 (SHA-1) may be utilized to process the token to obtain a hash value. In this instance, the hash value is the intermediate value which may be utilized to verify the token. A variety of other secure hash algorithms are also contemplated.

A sequence value is obtained (block 506) for the computed hash value. For example, the sequence value is typically sequential and may function for inventory purposes to track how many hash value have been generated, which hash values have been distributed, and so on.

A signature value is then computed using the hash value (block 508). The signature value may be configured as a “non-guessable” character string. For example, because of the sequential nature of sequence values, a malicious party may be able to guess a sequence value, and therefore the sequence value may not be suitable, by itself, for verifying if a user is in possession of an unusable (e.g., illegible) token. The signature value, however, may be configured such that it is not easily guessed, thereby providing a degree of security which is suitable for verifying whether a user is in possession of a token.

The signature value may be computed using the hash value in a variety of ways. For instance, a 25-digit token may be processed using SHA-1 to arrive at the hash value. A modulo operation may then be performed on the hash value to arrive at a value having fewer characters than the token, such as to generate a five digit integer (e.g., Modulo 100000) which could be positive or negative. If the five-digit integer is negative, a predetermine value (e.g., 10,000) is added to it to make it positive. If the five-digit integer is positive, no further processing is performed. Therefore, a result of this processing is the signature value.

A medium is then configured to include the token, the signature value, and the sequence value (block 510). For example, the signature value and the sequence value may be formed as exposed on the medium (block 512). The token, however, may be formed as hidden on the medium for later exposure (block 514). For example, the medium 300 of FIG. 3 is configured to include the signature 304 and the sequence value 306 as visible. The token 302, however, is formed on the medium 300 to be obscured by a material 308 which is formed on the token 302 for later removal. Although removal of material on the medium 300 is described for exposing the token 302, the token 302 may be hidden for later exposure in a variety of other ways.

The configured medium is then distributed (block 516). For example, the medium may be sold at a retail store for accessing a service (e.g., additional email storage, a downloadable song, a downloadable video, and so on) over a network. Exemplary utilization of the medium distributed by the procedure 500 of FIG. 5 is described in relation to the following figure.

FIG. 6 is a flow diagram depicting a procedure 600 in an exemplary implementation in which the medium distributed via the procedure 500 of FIG. 5 includes a signature value which is utilized to verify possession of the medium when the token is rendered illegible. A distributed medium is received (block 602). For example, the client may receive the distributed medium as a flyer in a periodical, purchase the medium from a store, and so on.

The client then attempts to expose the token (block 604) included on the medium. For example, the client may utilize a coin to “scratch off” material utilized to hide the token on the medium, may “tear off” a section of the medium hiding the token, and so on. During the attempted exposure, however, the token is rendered illegible (block 606). The client, for instance, may have used an overly vigorous motion when removing the scratch-off material, may have torn a portion of the medium which includes the token, and so forth. Consequently, the client contacts customer service and supplies the sequence value and the signature value (block 608). For instance, the client may send an email which includes the signature value and the sequence value to a customer service site referenced on the medium, may telephone a customer service number referenced on the medium, and so forth.

Customer service obtains a signature value using the sequence value (block 610). For example, the sequence value due to its sequential nature may be utilized as a index to “look-up” the stored signature value from storage 138. Customer service then verifies the supplied signature value using the obtained signature value (block 612), a result of which is then communicated (block 614). Customer service, for instance, may determine that the supplied signature value is not valid and communicate this result to the client. Customer service may also “mark” the obtained signature value in storage 138 (e.g., increment a counter) to indicate how many times that particular signature value 136(j) was accessed. Therefore, repeated access attempts may be detected and utilized to prevent a malicious party from guessing the signature value.

Although a variety of techniques have been described for generating, distributing, and verifying a signature value, a variety of other techniques may also be utilized. For example, the signature value and the sequence value may be utilized to verify if the client is in possession of the token. For instance, the client may communicate the signature value and the sequence value to the token verifier 110. The token verifier may then compute a hash value from a combination of the signature value and the sequence value, which is then compared to another hash value stored by the token verifier and retrievable via the sequence value. Thus, the sequence value may be utilized to “extend” the signature value for verification purposes.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
obtaining a token that represents an offer; and
associating the token with a signature value which is calculated using the token, wherein the signature value is configured for use in verifying that a user is in possession of the token.

2. A method as described in claim 1, wherein the calculating of the signature value includes:
generating an intermediate value from the token using a one-way function; and
processing the intermediate value to arrive at the signature value.

3. A method as described in claim 2, wherein the one-way function includes U.S. Secure Hash Algorithm Version 1.0.

4. A method as described in claim 1, wherein the offer relates to a good or service.

5. A method as described in claim 1, wherein the token is a product identifier.

6. A method as described in claim 1, wherein the associating includes configuring a medium to include the signature value and the token, wherein the medium is for distribution to the user.

7. A method as described in claim 6, wherein the configuring includes forming the token on the medium such that the token is not exposed for immediate viewing by the user.

8. A method as described in claim 1, further comprising associating a sequence value with the signature value and the token.

9. A method comprising:
receiving a communication of a signature value; and
verifying that a token which corresponds to the signature value is possessed by an originator of the communication by comparing the signature value with another value, wherein:
the other value is computed at least in part from an intermediate value; and
the intermediate value is computed at least in part by processing the token using a one-way function.

10. A method as described in claim 9, wherein the intermediate value is configured to verify the token.

11. A method as described in claim 10, wherein the intermediate value is a secure hash value of the token.

12. A method as described in claim 9, wherein the token is a product identifier.

13. A method as described in claim 9, wherein the one-way function is U.S. Secure Hash Algorithm Version 1.0 (SHA-1).

14. A method as described in claim 9, further comprising forming the communication when one or more characters which are included in the token are illegible to a user having a medium which includes the token and the signature value.

15. A method as described in claim 9, further comprising communicating a result of the verifying to the originator.

16. A method as described in claim 9, wherein the receiving and the verifying are performed through execution of one or more modules on a server that is communicatively coupled to the originator over a network.

17. A method as described in claim 9, wherein the verifying is for permitting utilization of an offer relating to a good or service by the originator.

18. A method comprising:
causing illegibility of at least a portion a token due to an attempt to expose the token on a medium; and
communicating a signature value included on the medium to verify possession of the medium, wherein the signature value is calculated using the token.

19. A method as described in claim 18, wherein:
the signature value is computed at least in part from an intermediate value; and
the intermediate value is computed at least in part by processing the token using a one-way function.

20. A method as described in claim 18, wherein:
the one-way function is U.S. Secure Hash Algorithm Version 1.0; and
the intermediate value is configured to verify the token.
